(19) United States
(12) Patent Application Publication
(10) Pub. No.: US 2012/0056750 A1
(43) Pub. Date: Mar. 8, 2012

(54) PRESSURE SENSOR DEVICE AND EMERGENCY INFORMING APPARATUS

(75) Inventors: Min-Joon Kim, Daejeon (KR); Sung-Dae Lim, Daejeon (KR)

(73) Assignee: H3 SYSTEM CO., LTD., Daejeon (KR)

(21) Appl. No.: 13/292,723

(22) Filed: Nov. 9, 2011

Related U.S. Application Data
(63) Continuation of application No. PCT/KR2010/001447, filed on Mar. 9, 2010.

(30) Foreign Application Priority Data
Jun. 1, 2009 (KR) 10-2009-0048202

(51) Int. Cl. G08B 21/00; G01L 7/00

(52) U.S. Cl. 340/665; 73/756

(57) ABSTRACT

Provided are a pressure sensor device and an emergency informing apparatus. The pressure sensor device includes a portable frame including a concave portion, a connector connected to the frame across the concave portion, a sensor disposed side by side with the connector and connected to the frame across the concave portion, a guard disposed to cover the connector and the sensor and extending in a direction perpendicular to a heading direction of the connector on a plane where the connector and the sensor are disposed, and a pressing unit disposed in the guard unit to cover the sensor and applying a pressure to the sensor.

### CROSS-REFERENCE TO RELATED APPLICATIONS

This application is a continuation of and claims priority to PCT/KR2010/001447 filed Mar. 9, 2010, which claims the benefit of and priority to Korean Patent Application No. 10-2009-0048202, filed on Jun. 1, 2009, the entireties of which are hereby incorporated by reference herein.

### BACKGROUND OF THE INVENTION

1. Field of the Invention

The present invention relates to pressure sensors device and, more particularly, to a pressure sensor device reacting with a force over a predetermined magnitude.

2. Description of the Related Art

When emergency occurs, an emergency informing system rapidly informs the emergency to cope with the emergency. An emergency informing system uses phone numbers (e.g., 119 number) to cope with situations such as fire, crime and so forth.

If a user informs an emergency by pressing button(s) of a terminal, an emergency informing system automatically accesses the 119 briefing room to automatically verify a previously registered address, a personal clinical history or the like. Accordingly, rapid mobilization and suitable first aid may be given even when there is difficulty in language communication for report.

An emergency informing system suffers from various disadvantages caused by malfunction. Conventionally, an emergency informing system operates with an emergency call button provided on a wired telephone.

### SUMMARY OF THE INVENTION

Embodiments of the present invention provide a portable pressure sensor device used in an emergency situation.

Embodiments of the present invention provide an emergency informing apparatus used in an emergency situation.

According to some embodiments of the present invention, a pressure sensor device may include a portable frame including a concave portion; a connector connected to the frame across the concave portion; a sensor connected to the frame across the concave portion; a guard extending to cover the connector and the sensor; and a pressing unit disposed in the guard to cover the sensor and applying a pressure to the sensor.

In an embodiment of the present invention, the pressure sensor device may further include a friction part disposed at a portion of the guard or a portion of the pressing unit to provide a friction force between the guard and the pressing unit.

In an embodiment of the present invention, the sensor is permanently deformed by the pressing unit

In an embodiment of the present invention, the sensor includes a piezo cable.

In an embodiment of the present invention, the sensor may further include a buffer tube disposed to cover the piezo cable and deformed by a force over a predetermined magnitude applied by the pressing unit.

In an embodiment of the present invention, the deformed buffer tube may continue to be deformed.

In an embodiment of the present invention, the sensor may include a piezo cable including a center electrode, a piezo element material, an outside electrode, and a coating film which are sequentially coated; a buffer tube disposed on the circumference of the piezo cable; a sensor fixing part disposed at a sensor groove formed at one side of the frame; and a sensor connector disposed at a sensor groove formed at the other side of the frame. One end of the sensor fixing part may be partially inserted into the buffer tube and the other end thereof may be fixedly connected to the frame, and the sensor connector may be electrically connected to the center electrode and the outside electrode.

In an embodiment of the present invention, the sensor may include a piezo cable including a center electrode, a piezo element material, an outside electrode, and a coating film which are sequentially coated; a buffer tube inserted into a sensor groove formed at one side of the frame and disposed in the circumference and one end of the piezo cable; and a connector disposed at a sensor groove formed at the other side of the frame. The sensor connector may be electrically connected to the center electrode and the outside electrode.

In an embodiment of the present invention, the sensor may be deformed by the operation of the pressing unit to output an electrical signal

In an embodiment of the present invention, the guard and the pressing unit may be flexible.

In an embodiment of the present invention, a pressure sensor may further include a sensor circuit sensing an electrical signal according to a pressure applied to the sensor. The sensor circuit may be disposed inside the frame.

In an embodiment of the present invention, the frame may further include at least one selected from the group consisting of a watch, a necklace, an accessory, a portable memory device, and a writing instrument.

In an embodiment of the present invention, the pressing unit may further include a protrusion protruding to the exterior of the guard.

According to other embodiments of the present invention, a pressure sensor device may include a connector connected to a portable frame; a sensor connected to the frame; a guard extending to cover the connector and the sensor; a pressing unit disposed in the guard to cover the sensor and applying a pressure to the sensor; and a sensor circuit sensing an electrical signal according to the pressure applied to the sensor.

According to another aspect of the present invention, an emergency informing apparatus may include a pressure sensor device; and a communication unit receiving an urgent signal from the pressure sensor device and transmitting an urgent message.

According to embodiments of the present invention, a pressure sensor device is mounted on a handheld product to provide a disposable switch that operates with a force over a predetermined magnitude when an emergency occurs.

### BRIEF DESCRIPTION OF THE DRAWINGS

For a more complete understanding of the present invention and the advantages thereof, reference is now made to the following descriptions taken in conjunction with the accompanying drawings, in which like reference numerals denote like parts, and in which:

FIGS. 1 to 3 illustrate a pressure sensor device according to one embodiment of the present invention;

FIG. 4 illustrates a sensor according to one embodiment of the present invention;

FIGS. 5 and 6 illustrate sensors according to other embodiments of the present invention;

FIG. 7 illustrates a watch including a pressure sensor device according to other embodiments of the present invention;

FIG. 8 illustrates an emergency informing apparatus including a pressure sensor device according to one embodiment of the present invention; and

FIG. 9 illustrates the configuration of an emergency informing system using a pressure sensor device according to an embodiment of the present invention.

### DETAILED DESCRIPTION OF EMBODIMENTS

A conventional switch for use in an emergency informing system may be easily restored during malfunction. For this reason, a user may unintentionally misuse or abuse the switch. Therefore, it is necessary for the switch to have difficulty in restoring force of the switch after the switch operates once.

A pressure sensor device according to one embodiment of the present invention may be a switch. The pressure sensor device may operate only with a force or weight over a predetermined magnitude. Since the pressure sensor device is disposable, there may be difficulty in its restoring force if it is deformed once. In addition, it is necessary to prevent the pressure sensor device from being found by the public in a situation such as kidnapping and robbery. Therefore, it is necessary to secretly mount the pressure sensor device on a handheld product.

The pressure sensor device according to one embodiment of the present invention may be directly mounted on a wired/wireless terminal, a wireless notebook computer, an IP telephone, a personal computer or the like. Alternatively, the pressure sensor device may be mounted on a handheld product such as a watch, a necklace, or a personal digital assistant (PDA), etc. A signal of the pressure sensor device may transmit information to an urgent server through conventional wired/wireless communication network and a wired/wireless integrated exchanger.

Preferred embodiments of the present invention will now be described more fully hereinafter with reference to the accompanying drawings, in which preferred embodiments of the present invention are shown. However, the present invention may be embodied in many different forms and should not be construed as limited to the embodiments set forth herein. Rather, these embodiments are provided so that this disclosure will be thorough and complete, and will fully convey the scope of the present invention to those skilled in the art. In the drawings, elements are exaggerated for clarity. Like numbers refer to like elements throughout.

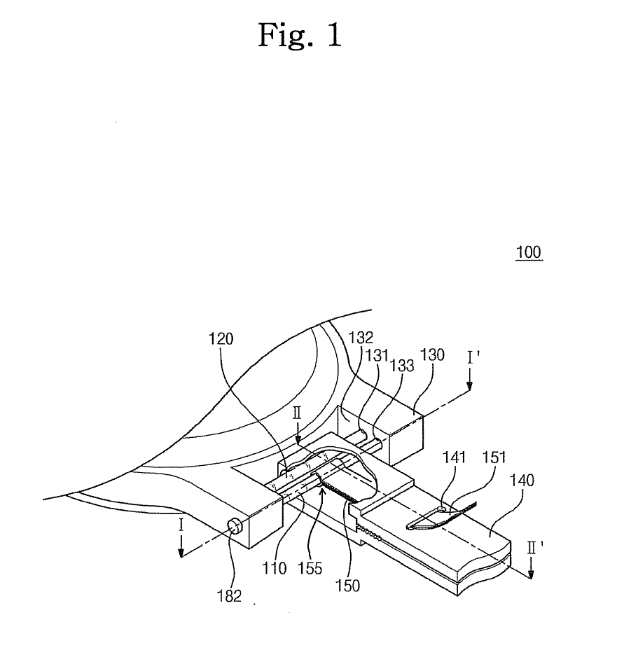

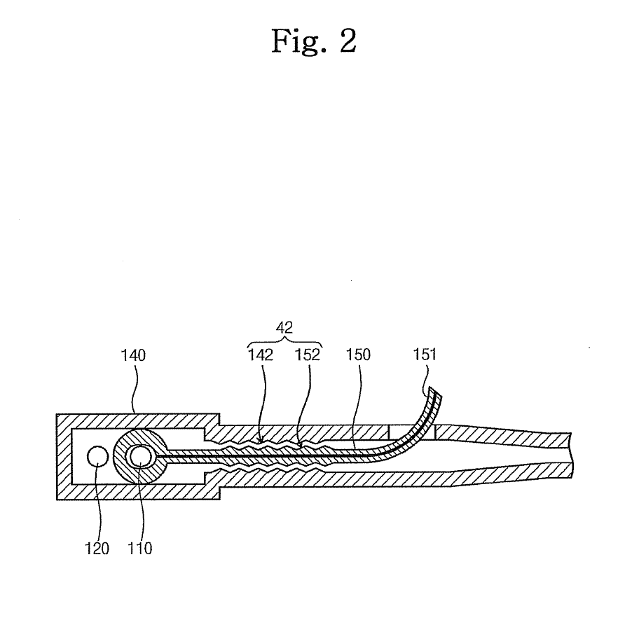

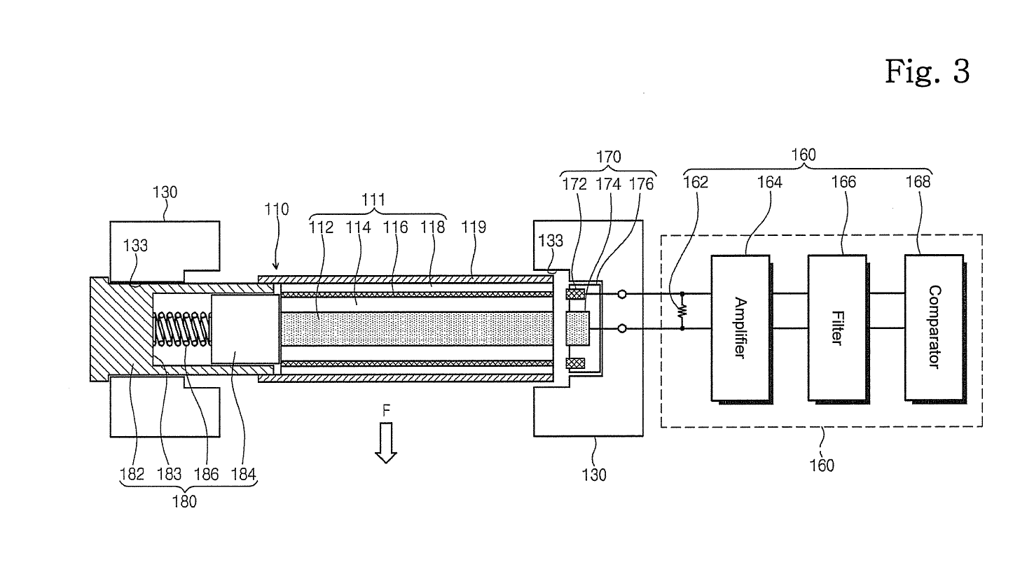

FIGS. 1 to 3 illustrate a pressure sensor device 100 according to one embodiment of the present invention. FIG. 2 is a cross-sectional view taken along the line I-I′ in FIG. 1, and FIG. 3 is a cross-sectional view taken along the line II-II I′ in FIG. 1.

Referring to FIG. 1, the pressure sensor device 100 includes a portable frame 130 including a concave part 132. A connector 120 is connected to the frame across the concave part 132. A sensor 110 is disposed side by side with the connector 120 and connected to the frame 130 across the concave part 132. A guard 140 is disposed to cover the connector 120 and the sensor 110 and extends in a direction perpendicular to the heading to a direction of the connector 120 on a plane where the connector 120 and the sensor 110 are disposed. A pressing unit 150 is disposed in the guard to cover the sensor 110. The pressing unit 150 includes a protrusion 151 protruding to the exterior of the guard 140 and applies a pressure to the sensor 110.

The frame 130 may be a part of handheld product such as a watch, a necklace, an accessory, a cell phone, a portable memory device, or a writing instrument, etc. The frame 130 is not limited thereto and may be a part of any portable product. The frame 130 may be a general phone or a computer. The frame 130 may have the concave part 132. The frame 130 may have a fixed shape such as metals or plastics. The frame 130 may not be readily deformed by force or weight. The shape of the concave part 132 may be variously deformed as long as the sensor 110 and the connector 120 can be disposed.

The connector 120 may be connected to the frame 130 across the concave part 132. The connector 120 may have a stick shape. The connector 120 may include a spring part (not shown) to be connected to the frame 130. The connector 120 may have the configuration similar to a configuration for connecting a watch to a watchstrap. The connector 120 may be readily deformed by force or weight. The connector 120 may include at least one selected from the group consisting of iron, nickel, molybdenum, and tungsten. The connector 120 may be put in a connection groove 131 farmed at the frame 130. The connector 120 may be inserted into the connection groove 131.

The sensor 110 may be disposed side by side with the connector 120 and connected to the frame 130 across the concave part 132. The sensor 110 may have a stick shape. The sensor 110 may be deformed by the force applied by the pressing unit 150. The sensor 110 may be permanently deformed by the pressing part 150. The sensor 110 may include a piezo cable. A buffer tube (not shown) may coat the piezo cable. The piezo cable may be inserted into a sensor groove 133. A fixture pin 182 may fix the buffer tube to the frame 130.

The guard 140 may have a buffer space 155 to rotate on the connector 120 and the sensor 110. The protrusion 151 may be protruded through an opening 141 formed at the guard 140.

Referring to FIG. 2, the guard 140 may cover the connector 120 and the sensor 110 and extend in a direction perpendicular to the heading direction of the connector 120 on a plane where the connector 120 and the sensor 110 are disposed. The guard 140 may have flexibility and restoring force. The guard 140 may include at least one selected from the group consisting of metal, plastic, fiber, leather, polymer, and rubber. The guard 140 may have a folded band shape to cover the connector 120 and the sensor 110. One side of the guard 140 is disposed to cover the connector 120 and the sensor 110, and the other side thereof may be bonded by overlapping the band shape. The guard 140 may have constant width. The guard 140 may have a buffer space 155 to rotate on the connector 120 and the sensor 110.

The pressing unit 150 may be disposed inside the guard 140 to cover the sensor 110. The pressing unit 150 may include a protrusion 151 protruding to the exterior of the guard 140. The pressing unit 150 may have flexibility and restoring force. The pressing unit 150 may have a folded band shape to cover the sensor 110. The pressing unit 150 may be made of the same material as the guard 140. The protrusion 151 may be buried in the guard 140, and a user may pull the protrusion 151 by taking out the protrusion 151 therefrom. The pressing unit 150 may have smaller width than the guard 140. When the user pulls the protrusion 151 with a force over a predetermined magnitude, a force or a weight may be applied to the sensor 110. The sensor 110 may be deformed by the pressing unit 150 to generate an electrical signal.

A friction part 42 is disposed at a portion of the guard 42 and a portion of the pressing unit 150 to provide a friction force between the guard 140 and the pressing unit 150. The friction part 42 may include a guard friction part 142 disposed at the guard 140 and a pressing friction part 152 disposed at the pressing unit 150. The guard friction part 142 and the pressing friction part 152 may face each other. The pressing friction unit 152 and the guard friction part 142 may be made of a material having an excellent friction force or may have a shape with a great friction force. The friction part 42 may be variously modified as long as it can increase the friction force between the guard 140 and the pressing unit 150. The friction part 42 may have an uneven shape. When the user applies a force below a predetermined magnitude to the pressing unit 150, the friction part 42 may provide means that is not be deformed by the guard 150. Alternatively, the friction part 42 may provide means that does not provide deformation to the sensor 110 with respect to conventional deformation of the guard 140.

In the case that the frame 130 is a part of a watch, the guard 140 may be a watchstrap and the pressing 150 may be embedded in the watchstrap. In the case that the frame 130 is a necklace, the guard 140 may be a part of a line of the necklace. In the case that the frame 130 is an accessory, the guard 140 may be a part of the accessory.

Referring to FIG. 3, the sensor 110 may include a buffer tube 119 that covers the piezo cable 111 and is deformed by a force over a predetermined magnitude applied to the pressing unit 150. The deformed buffer tube 119 may continue to be deformed. Due to the operation of the pressing unit 150, the sensor 110 may be deformed to output an electrical signal. The sensor 110 may be disposed at a sensor groove 133 formed at the frame 130.

The piezo cable 111 may include a center electrode 112 disposed in its center in an axial direction, a piezo element material 114 coating the periphery of the center electrode, an outside electrode 116 disposed in the periphery of the piezo element material 114, and a coating film 118 coating the outside electrode 116. The buffer tube 119 may be disposed on the circumference of the coating film 118.

The sensor 110 may include the piezo cable 111, the buffer tube 119 disposed on the circumference of the piezo cable 111, a sensor fixing part 180 disposed at a sensor groove 133 formed at one side of the frame 130, and a sensor connector 170 disposed at a sensor groove 133 formed at the other side of the frame 130. One end of the sensor fixing part 180 may be partially inserted into the buffer tube 119, and the other end thereof may be fixedly joined to the frame 130. One end of the piezo cable 111 may be in contact with the sensor fixing part 180, and the other end thereof may be in contact with the sensor connector 170. The sensor connector 170 may be electrically connected to the center electrode 112 and the outside electrode 116.

The sensor fixing part 180 may include a fixation pin 182, a spacer 184, and a spring 186. The fixation pin 182 may include a fixation groove 183. The spring 186 may be inserted into the fixation groove 183. The spacer 184 may be disposed inside the fixation groove 183. The spring 186 may apply a repulsive force to the spacer 184. The fixation pin 182 may be fixedly joined to the sensor groove 133. The fixation pin 182 may be inserted into the buffer tube 119. The spring 186 may allow the spacer 184 and the piezo cable 111 to be closely adjacent to each other.

The sensor connector 170 may be disposed at the sensor groove 133 formed at the other side of the frame 130. The sensor connector 170 may include an insulator body 176, a center connector 174, and an external connector 172. The center connector 174 and the external connector 172 may be mounted on the insulator body 176. The center connector 174 may be electrically connected to the center electrode 112. The external connector 172 may be electrically connected to the outside electrode 116.

The sensor circuit 160 may sense an electrical signal according to deformation of the sensor 110. The sensor circuit 160 may include a resistor 162, an amplifier 164, a filter 166, and a comparator 168. The resistor 162 may be joined between the center electrode 112 and the outside electrode 116. When the piezo cable 111 is short-circuited, the resistor 162 may provide a determination whether the piezo cable 111 is short-circuited. The amplifier 164 may amplify an output signal of the sensor 110. The filter 166 may remove unwanted signals caused by conventional vibration. The comparator 168 may output a signal after comparing an output signal with a reference signal. When the pressing unit 150 provides a force over a predetermined magnitude to the sensor 110, the comparator 168 may provide an output signal.

When the user pulls the pressing unit 150 with a force over a critical magnitude, the pressing unit 150 may eliminate electrical connection between the sensor 110 and the sensor circuit 160 configured to process an electrical signal of the sensor 110.

According to a modified embodiment of the present invention, the sensor 110 has a structure that is deformed by the pressing unit to be electrically open with respect to the sensor circuit 160.

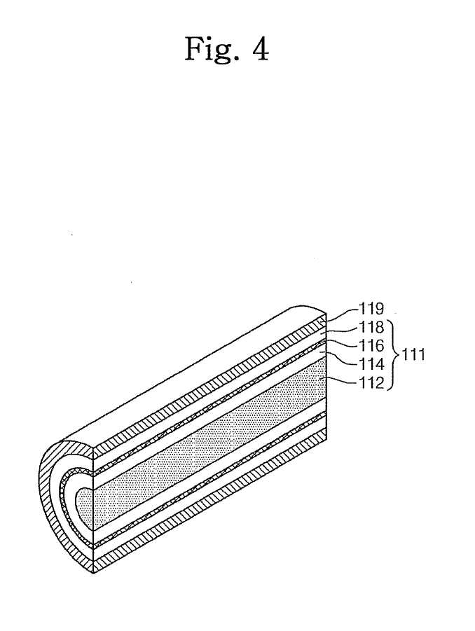

FIG. 4 illustrates a sensor according to one embodiment of the present invention.

Referring to FIG. 4, the sensor may include a piezo cable 111 and a buffer tube 119 disposed on the circumference of the piezo cable 111. The piezo cable 111 may include a center electrode 112 disposed in its center in an axial direction, a piezo element material 114 coating the periphery of the center electrode, an outside electrode 116 disposed in the periphery of the piezo element material 114, and a coating film 118 coating the outside electrode 116. The buffer tube 119 may be disposed on the circumference of the coating film 118.

The piezo cable 111 may have superior flexibility and generate an output signal according to deformation acceleration. The piezo element material 114 may include piezoelectric ceramic. The piezo element material 114 may include lead titanium-oxide, a sinter pulverulent body of lead titanium-oxide zirconium oxide, or a sinter pulverulent body of non-lead piezo-ceramic such as sodium niobate. The piezo element material 114 may be polymeric uniaxially stretched polyfluoridevinylidene or chloroprene and piezoelectric ceramic powder. Alternatively, the piezo element material 114 may comprise resin and piezo ceramics.

The center electrode 112 and the outside electrode 116 may have flexibility. The center electrode 112 may be a single-line electrode or a multi-line electrode. The center electrode 112 may be a copper-silver alloy. The outside electrode 116 may be a triple layered laminated film of copper or aluminum-polyethylene terephthalate-aluminum (Al-PET-Al). The piezo element material 114 may include polyethylene-based resin and piezoelectric ceramic particle. The coating film 118 may be thermoplastic or polyethylene.

The buffer tube 119 may include at least one selected from the group consisting of aluminum, tin, copper, and lead. The buffer tube 119 may be not readily deformed by the pressing unit 150. The buffer tube 119 may be deformed only when a force over a predetermined magnitude is applied to the buffer tube 119 by the pressing unit 150. Accordingly, the buffer tube 119 may have a function to prevent deformation with weak tension. If flexibility of the buffer tube 119 increases, the piezo cable 111 may generate an electrical signal even when a gentle force is applied to the buffer tube 119 by the pressing unit 150. However, the piezo cable 111 may generated an unnecessary electrical signal due to perturbation. Therefore, the buffer tube 119 is preferably bent when a force over a predetermined magnitude is applied to the buffer tube 119. Since the buffer tube 119 does not have restoring force, it is preferably deformed permanently. The buffer tube 119 may be preferably made of metal. The buffer tube 119 may have an electromagnetic field shielding function for the center electrode 112 to remove noise.

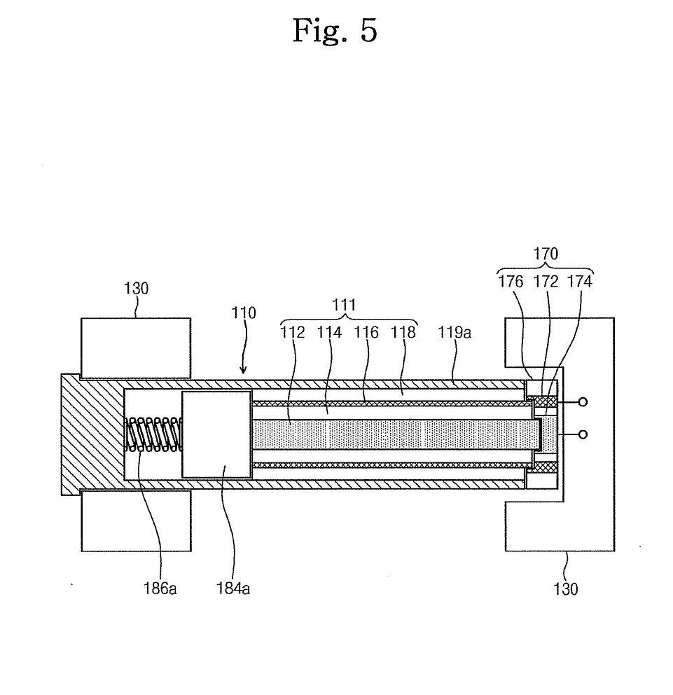

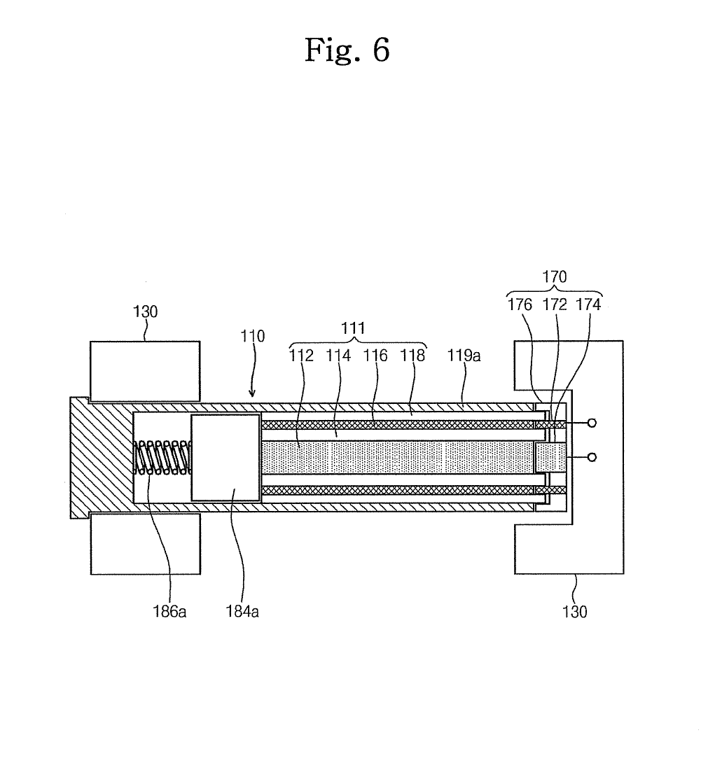

FIGS. 5 and 6 illustrate sensors according to other embodiments of the present invention.

Referring to FIG. 5, a sensor 110 may include a piezo cable 111, a buffer tube 119a, and a sensor connector 170. The piezo cable 111 may include a center electrode 112, a piezo element material 114, an outside electrode 116, and a coating film 118 which are sequentially coated. The buffer tube 119 may be disposed on the circumference and one end of the piezo cable 111. The sensor 110 may include a spring 186a and a spacer 184a. One end of the buffer tube 119a may be blocked. The spring 186a and the spacer 184a may be disposed inside the buffer tube 119a. The spring 184a may allow the piezo cable 111 to closely adhere to the sensor connector 170 through the spacer 184a. The other end of the piezo cable 111 may have a step-shaped section. The center electrode 112 may be protruded the most. That is, the other end of the piezo cable 111 may have a protruding structure as its radius decreases. The sensor connector 170 may be in electrical and mechanical contact with the other end of the piezo cable 111. The sensor connector 170 may include an insulator body 176, a center connector 174, and an outer connector 172. The center connector 174 may be electrically connected to the center electrode 112. The outer connector 172 may be electrically connected to the outside electrode 116.

Referring to FIG. 6, a sensor 110 may include a piezo cable 111, a buffer tube 119a, and a sensor connector 170. The piezo cable 111 may include a center electrode 112, a piezo element material 114, an outside electrode 116, and a coating film 118 which are sequentially coated. The buffer tube 119a may be disposed on the circumference and one end of the piezo cable 111. The sensor 110 may include a spring 186a and a spacer 184a. One end of the buffer tube 119a may be blocked. The spring and the spacer 184a may be disposed inside the buffer tube 119a. The spring 186a may allow the piezo cable 111 to closely adhere to the piezo cable 111 through the spacer 184a. The other end of the piezo cable 111 may have an uneven section. The piezo element material 114 and the coating film 118 may be protruded. The sensor connector 170 may be in electrical and mechanical contact with the other end of the piezo cable 111. The sensor connector may include an insulator body 176, a center connector 174, and an outer connector 172. The center connector 174 may be electrically connected to the center electrode 112. The outer connector 172 may be electrically connected to the outside electrode 116. There may be various methods for connecting the piezo cable 111 to the sensor connector 170.

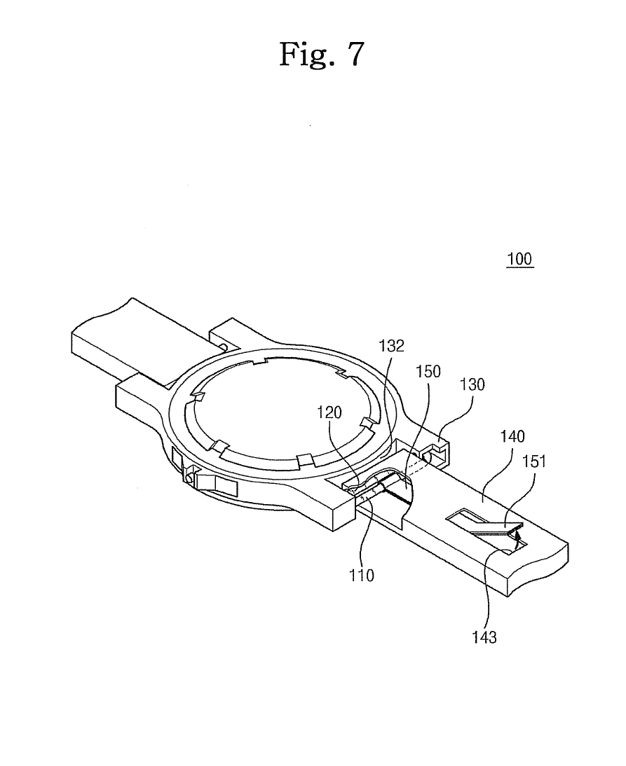

FIG. 7 illustrates a watch including a pressure sensor device according to other embodiments of the present invention.

Referring to FIG. 7, the pressure sensor device incorporates with a watch. The pressure sensor device 100 includes a frame 130 including a concave portion 132. A connector 120 is connected to the frame 130 across the concave portion 132. The sensor 110 is disposed side by side with the connector 120 and connected to the frame 130 across the concave portion 132. A guide 140 covers the connector 120 and the sensor 110 and extends in a direction perpendicular to the heading direction of the connector 120 on a plane where the connector 120 and the sensor 110 are disposed.

A pressing unit 150 is disposed in the guard 140 to cover the sensor 110. The pressing unit 150 includes a protrusion 151 protruding to the exterior of the guard 140 and applies a pressure to the sensor 110. The protrusion 151 may be disposed to be buried in a burial region 143 formed at the guard 140. The sensor 110 may extend into the frame 130. Both ends of the sensor 110 may be deformed variously as long as they can be deformed by the pressing unit 150. The sensor 110 may be electrically connected to a sensor circuit (not shown) disposed inside the frame 130.

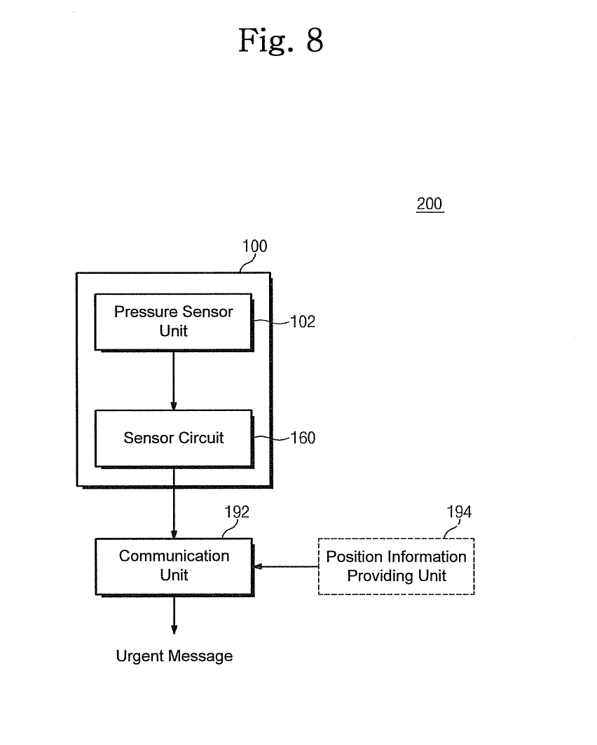

FIG. 8 illustrates an emergency informing apparatus including a pressure sensor device according to one embodiment of the present invention.

Referring to FIG. 8, an emergency informing apparatus 200 communicates with a terminal directly connected to a network or a terminal connected to a network. Therefore, the emergency informing apparatus 200 may include, for example, a terminal (a wired telephone, a wireless telephone, a personal computer (PC), a notebook computer, an IP phone, a cellular phone, a personal digital assistant (PDA), or a net-book computer, etc.), a watch, a necklace, an MP3 player, a personal multimedia player (PMP) or the like.

The emergency informing apparatus 200 may include a pressure sensor device 100 and a communication unit 192. In addition, the emergency informing apparatus 200 selectively includes a position information providing unit 194. The communication unit 192 receives an urgent signal from the pressure sensor device 100. The pressure sensor device 100 may include a pressure sensor unit 102 and a sensor circuit 160.

Referring to FIGS. 8 and 3, the pressure sensor unit 102 may include a connector 120 connected to a portable frame 130, a sensor 110 connected to the frame 130, a guard 140 extending to cover the connector 120 and the sensor 110, and a pressing unit 150 disposed in the guard 140 to cover the sensor 110 and applying a pressure to the sensor 110. The sensor circuit 160 may an electrical signal according to the pressure applied to the sensor 110.

First, described is a case where the emergency informing apparatus 200 is directly connected to a network. The communication unit 192 generates an urgent message to inform an emergency situation by using an urgent signal. The communication unit 192 transmits an urgent message through the connected network. When the position information providing unit 194 is included, the communication unit 192 receives position information from the position information providing unit 194 according to the control of a controller (not shown). An urgent message of the communication unit 192 may include position information.

Next, described is a case where the communication unit 192 communicates through a terminal (not shown) connected to a network. The communication unit 192 transmits an urgent signal received from the pressure sensor device 100 to the terminal. When the position information providing unit 194 is included, the communication unit 192 receives position information from the position information providing unit 194 according to the control of a controller (not shown). The communication unit 192 transmits the position information with an urgent signal to the terminal. The terminal receiving the urgent signal generates an urgent message to inform an urgent situation. The terminal transmits an urgent message through the connected network.

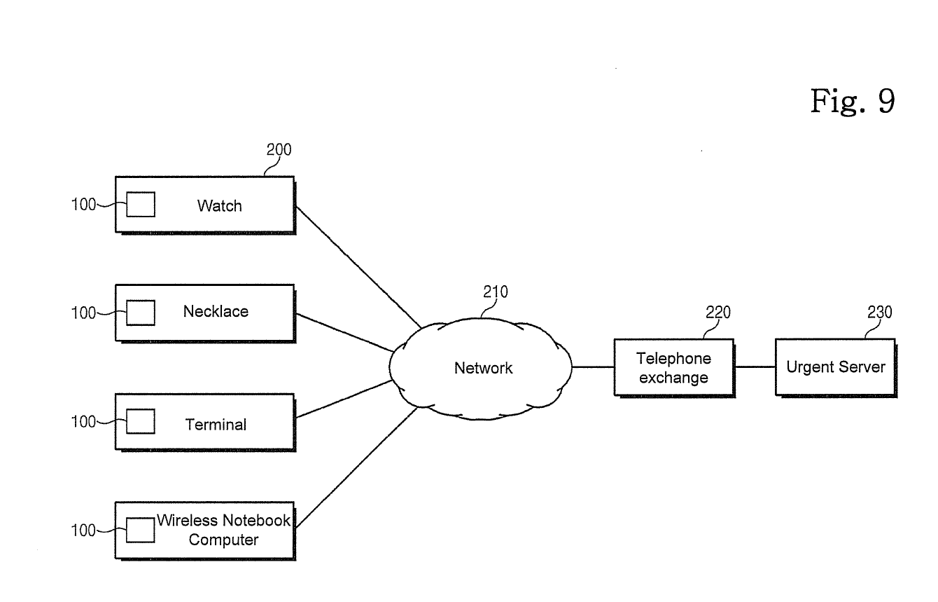

FIG. 9 illustrates the configuration of an emergency informing system employing a pressure sensor device according to an embodiment of the present invention.

Referring to FIG. 9, an emergency informing system 200 transmits an urgent message to a network 210. The network 210 includes wired/wireless networks. If receiving an urgent message, the network 210 transmits a received urgent message to a telephone exchanger 220. The telephone exchanger 220 transmits an urgent message to a predetermined urgent server 230. If receiving an urgent message among transmitted/received messages, the network 210 or the telephone exchanger 220 may process an urgent message prior to other general messages.

What is claimed is:

1. A pressure sensor device comprising:
a portable frame including a concave portion;
a connector connected to the frame across the concave portion;
a sensor connected to the frame across the concave portion;
a guard extending to cover the connector and the sensor; and
a pressing unit disposed in the guard to cover the sensor and applying a pressure to the sensor.

2. The pressure sensor device of claim 1, further comprising:
a friction part disposed at a portion of the guard and a portion of the pressing unit to provide a friction force between the guard and the pressing unit.

3. The pressure sensor device of claim 1, wherein the sensor is permanently deformed by the pressing unit

4. The pressure sensor device of claim 1, wherein the sensor includes a piezo cable.

5. The pressure sensor device of claim 4, wherein the sensor further includes a buffer tube disposed to cover the piezo cable and deformed by a force over a predetermined magnitude applied by the pressing unit.

6. The pressure sensor device of claim 4, wherein the deformed buffer tube continues to be deformed.

7. The pressure sensor device of claim 1, wherein the sensor includes:
a piezo cable including a center electrode, a piezo element material, an outside electrode, and a coating film which are sequentially coated;
a buffer tube disposed on the circumference of the piezo cable;
a sensor fixing part disposed at a sensor groove formed at one side of the frame; and
a sensor connector disposed at a sensor groove formed at the other side of the frame,
wherein one end of the sensor fixing part is partially inserted into the buffer tube and the other end thereof is fixedly connected to the frame, and the sensor connector is electrically connected to the center electrode and the outside electrode.

8. The pressure sensor device of claim 1, wherein the sensor includes:
a piezo cable including a center electrode, a piezo element material, an outside electrode, and a coating film which are sequentially coated;
a buffer tube inserted into a sensor groove formed at one side of the frame and disposed in the circumference and one end of the piezo cable; and
a sensor connector disposed at a sensor groove formed at the other side of the frame,
wherein the sensor connector is electrically connected to the center electrode and the outside electrode.

9. The pressure sensor device of claim 1, wherein the sensor is deformed by the operation of the pressing unit to output an electrical signal

10. The pressure sensor device of claim 1, wherein the guard and the pressing unit are flexible.

11. The pressure sensor device of claim 1, further comprising:
a sensor circuit sensing an electrical signal according to the pressure applied to the sensor,
wherein the sensor circuit disposed inside the frame.

12. The pressure sensor device of claim 1, wherein the frame further includes at least one selected from the group consisting of a watch, a necklace, an accessory, a portable memory device, and a writing instrument.

13. The pressure sensor device of claim 1, wherein the pressing unit further includes a protrusion protruding to the exterior of the guard.

14. A pressure sensor device comprising:
a connector connected to a portable frame;
a sensor connected to the frame;
a guard extending to cover the connector and the sensor;
a pressing unit disposed in the guard to cover the sensor and applying a pressure to the sensor; and
a sensor circuit sensing an electrical signal according to the pressure applied to the sensor.

15. An emergency informing apparatus comprising:
a pressure sensor device set forth in claim 14; and
a communication unit receiving an urgent signal from the pressure sensor device and transmitting an urgent message.
